(19) United States
(12) Patent Application Publication
(10) Pub. No.: US 2022/0299411 A1
(43) Pub. Date: Sep. 22, 2022

(54) RAPID MEASUREMENT SYSTEMS AND METHODS FOR PLASTIC ARTICLES

(71) Applicant: Alltrista Plastics LLC, Greer, SC (US)

(72) Inventor: Saumitra BHARGAVA, Clarksville, MD (US)

(21) Appl. No.: 17/753,322

(22) PCT Filed: Sep. 4, 2020
(86) PCT No.: PCT/US2020/049381

§ 371 Date: Feb. 28, 2022

Related U.S. Application Data
(60) Provisional application No. 62/897,069, filed on Sep. 6, 2019.

(51) Int. Cl. G01N 3/08; G01N 23/223; G01N 35/00; G01N 3/06; B29C 49/80

(52) U.S. Cl. CPC G01N 3/08; G01N 23/223; G01N 35/0099; G01N 3/06; B29C 49/80; G01N 2223/076; G01N 2223/507; G01N 2223/623; G01N 2223/652; G01N 2203/0019; G01N 2203/06; G01N 2203/0058; B29C 2049/78715

(57) ABSTRACT

Systems and methods for rapid measurement of the chemical and structural properties of plastic articles are provided. The systems and methods involve measuring both mechanical deformation of the plastic article and x-ray fluorescence of the plastic article in order to determine changes in composition as a result of contamination and/or issues associated with plastic article manufacturing lines. The systems and methods can be performed in minutes, compared to hours or days for typical testing methods.

### CROSS-REFERENCE TO RELATED APPLICATIONS

This application claims priority benefit of U.S. Provisional Patent Application No. 62/879,069, filed Sep. 6, 2019, the disclosure of which is incorporated by reference herein in its entirety.

### BACKGROUND

The present disclosure relates generally to the manufacture of plastic articles, and more specifically relates to measurement systems for ensuring manufactured articles are within acceptable deviation of product specifications.

Compression blow forming, injection blow molding, and extrusion blow molding techniques are known that produce plastic packaging articles, such as containers like bottles, at a rate of 2,000-12,000 pieces an hour. Numerous inline and offline techniques exist. However, existing methods suffer from limitations on the amount of time required for testing manufactured articles to ensure conformity to product specifications. For example, there are multiple tests currently used that take hours or up to a day to complete. Thus, in situations where non-conforming products are being produced, a 4-hour long compliance test can result in a loss of 8,000-48,000 containers. Often, a machine can run 20,000-2,000,000 bottles and even as high as 14 million bottles before barrier test results are received. Besides being resource intensive, minimum time requirements for many known tests result in production of large volumes of non-conforming “off-spec” products that have to be disposed of in bulk.

There have been instances in which molecular contamination of a resin has resulted in a recall of hundreds of thousands of medicine bottles from store shelves. Thus, it would be beneficial for packagers and manufacturers to have high assurance of article fitness and functionality as they are being produced or rapidly after production.

Accordingly, there exists a need for being able to quickly and accurately measure chemical and structural properties of plastic articles.

### BRIEF DESCRIPTION OF THE DRAWINGS

The detailed description is set forth with reference to the drawings, which are meant to be exemplary and not limiting, illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

FIG. 1 illustrates one embodiment of an inline measurement system of the present disclosure.

FIG. 2 illustrates one embodiment of a measurement system of the present disclosure.

FIG. 3 illustrates one embodiment of a fixture for use in a measurement system of the present disclosure.

FIG. 4 illustrates one embodiment of a measurement system of the present disclosure.

### DETAILED DESCRIPTION

The present disclosure will now be described by reference to more detailed embodiments. This disclosure may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this disclosure belongs. The terminology used in the disclosure herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and appended claims are approximations that may vary depending upon the desired properties sought to be obtained by the present invention. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

As discussed herein, embodiments of the present disclosure beneficially provide for improved methods and systems of quickly and accurately measuring chemical and structural properties of plastic articles, such as molded containers and other packaging, e.g., bottles. These systems and methods may be particularly useful in industries and applications in which articles must display low deviation from acceptable standards (e.g., food and drug applications). For example, the methods and systems described herein may be used in concert with known plastic forming equipment and techniques including, for example, suitable forming and molding processes, such as injection and compression molding (e.g., compression blow forming, injection blow molding, and extrusion blow molding). For example, the described methods and systems may be incorporated inline or offline with plastic forming equipment and processes.

As used herein, an “inline” test refers to one that is performed on a production line, without removal of the article from, e.g., a conveyor belt. As used herein, a “lab” or “offline” test refers to one in which the article is removed from the production line or production facility and tested in a spatially separated setting, such as a lab.

Methods

In certain embodiments, a method for measuring specification compliance (e.g., of chemical and/or structural properties) of a plastic article includes: performing x-ray fluorescence (XRF) on a plastic article to identify U.S. Pharmacopeial Convention (USP) elements of concern, nucleating agent level, and/or delustrant level, and performing a non-destructive mechanical test on the plastic article, with the mechanical test involving depressing a portion of the plastic article at a defined rate and determining a force required to deform the portion of the article and the force associated with releasing the depression at a defined rate, to identify any shift in material composition or processing parameters of the article.

As used herein, a “shift in material composition” refers to any change in the composition of the article, which in turn may increase or decrease crystallinity and stiffness. The shift in composition may influence sidewall thickness directly resulting from crystallinity change or combination of process and shift in material composition. A “shift in processing parameters” refers to an abnormal temperature, greater or lesser residence time, abnormal shifts in shear arising from temperature changes. These shifts are imperceptible without testing, but cannot be addressed until a sample article has been tested and the cause of the shift is identified.

Such methods have been found to provide a significantly shorter and more efficient way to determine molecular contamination and other chemical and structural issues in association with plastic article manufacturing lines. As discussed, these improvements allow plastic article manufacturers to assess in close to real-time any processing or material deficiencies in its manufacturing processes, providing a significant reduction in process downtime and production of inferior or unusable articles.

For example, the mechanical properties of plastic articles may be highly influenced by inorganic additives, processing conditions, and organic contaminants present within the polymer. Assessing such deficiencies or changes within the manufacturing process typically requires performing destructive analysis on the articles. Also, as discussed above, there is a significant time required for known tests. Moreover, often, a sample is sent to an outside lab to perform a top loading test, which can lead to missed changes in product. Existing contamination detection systems are only able to identify hard gels and black specks in the polymer resin. In contrast, the measurement systems and methods described herein provide the ability to identify the presence of inorganic contaminants at the 10-20 ppm level, within minutes, as well as organic contaminants, which impact article functionality. For example, the methods and systems described herein may provide for complete testing and results in less than five minutes, and often in even less time, such as from 1 to 3 minutes.

The first analytical method of the present invention is XRF, which can identify: (i) any present USP elements of concern, such as arsenic, cadmium, lead, and mercury, (ii) nucleating agent level, and/or (iii) delustrant level, in an article. It was determined that such an XRF test can be performed in about 1 minute, to provide an alternative to traditional WVTR (water vapor transmission rate) testing, which takes 60 days, while also being effective to measure all USP elements of concern, and replace an ash test for delustrant/TiO₂ content. Furthermore, active pharmaceutical ingredients (API) with non-carbon elements can be quantitatively measured for process control.

As used herein, “USP elements of concern” refer to those elements, such as arsenic, cadmium, lead, and mercury that have been identified by the United States Pharmacopeial Convention as those that must be considered in any risk assessment of a drug product, such as a plastic article.

As used herein, a “nucleating agent” refers to a chemical, compound, substance, or the like that promotes crystallization of polymers, such as aromatic carboxylic acid salts, phosphate ester salts, potassium stearate, sodium benzoate, talc, and the like. While nucleating agents reduce cycle times, they also increase modulus and moisture barrier properties.

As used herein, a “delustrant” refers to a chemical, compound, substance, or the like that blocks light, such as titanium dioxide (TiO₂).

The second analytical method of the present invention is a non-destructive mechanical test, which also may be performed in about 1 minute. In certain embodiments of the mechanical test, a sample article is deformed slightly and this deformation is elastic in nature, resulting in full recovery of the part functionality. In certain embodiments, a fixture is used to secure the sample article and ensure testing conditions are uniform between samples. This test may provide rapid analysis of contamination or process shift, which is a key to minimizing article weight while maintaining a high degree of confidence that the articles will meet specifications and function in use. The mechanical test provides direct measurement of mechanical properties after processing, and may serve as an alternative to WVTR, OTR (oxygen transmission rate) type measurements, and/or top loading crush tests.

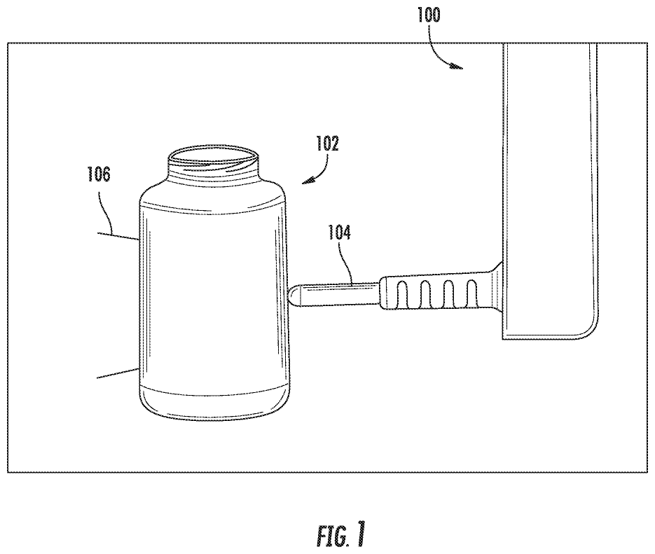

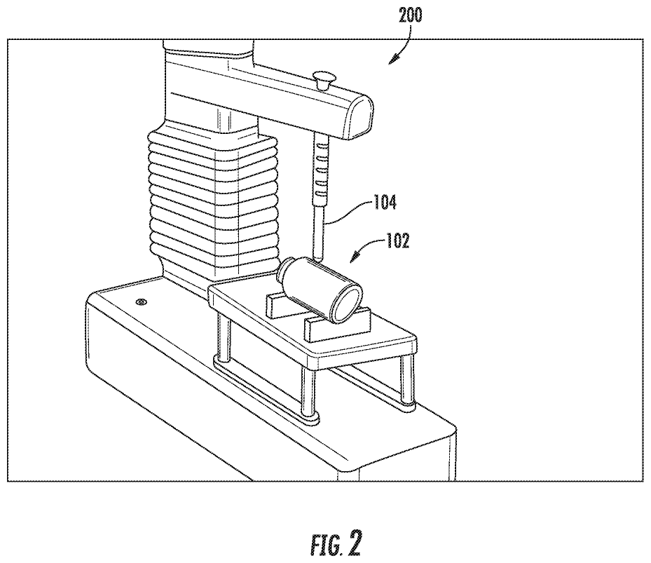

In certain embodiments, as shown in FIGS. 1-2, the mechanical test is performed by an instrumented finger 104 having or associated with a force gauge, in which the instrumented finger 104 depresses a portion of the sidewall of the article 102 affixed to a mount 106 at a defined rate and the force required to deform the portion of the article is determined. The instrumented finger 104 is then removed from the portion of the article at a defined rate and the force associated with removal of the finger 104 is also determined. For example, the instrumented finger may be a sensitive moving head associated with a force gauge. The force to deform slightly may be recorded continuously along with monitoring the force when removing the finger at the defined rate. It has been found that this measurement is able to quickly identify process changes, loading level of inorganic materials, which influence mechanical properties, and low molecular weight polymeric additives to base resin.

In certain embodiments, as shown in FIG. 1, the sidewall of the article is measured while the article is positioned vertically, i.e., the longitudinal axis of the article is perpendicular to the ground while the instrumented finger is parallel to the ground. In certain embodiments, as shown in FIG. 2, the sidewall of the article is measured while the article is positioned horizontally, i.e., the longitudinal axis of the article is parallel to the ground while the instrumented finger is perpendicular to the ground.

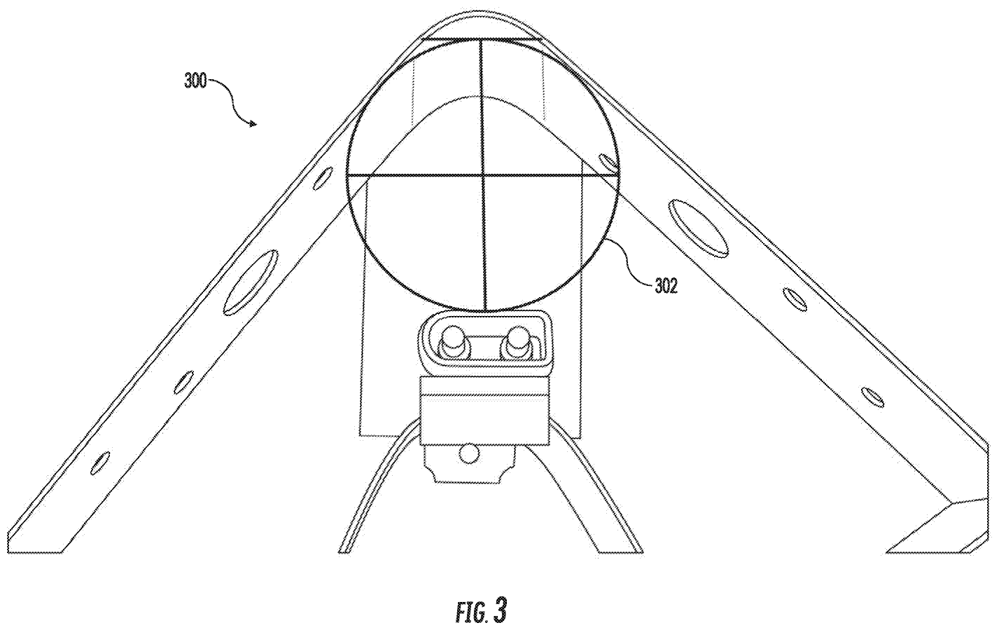

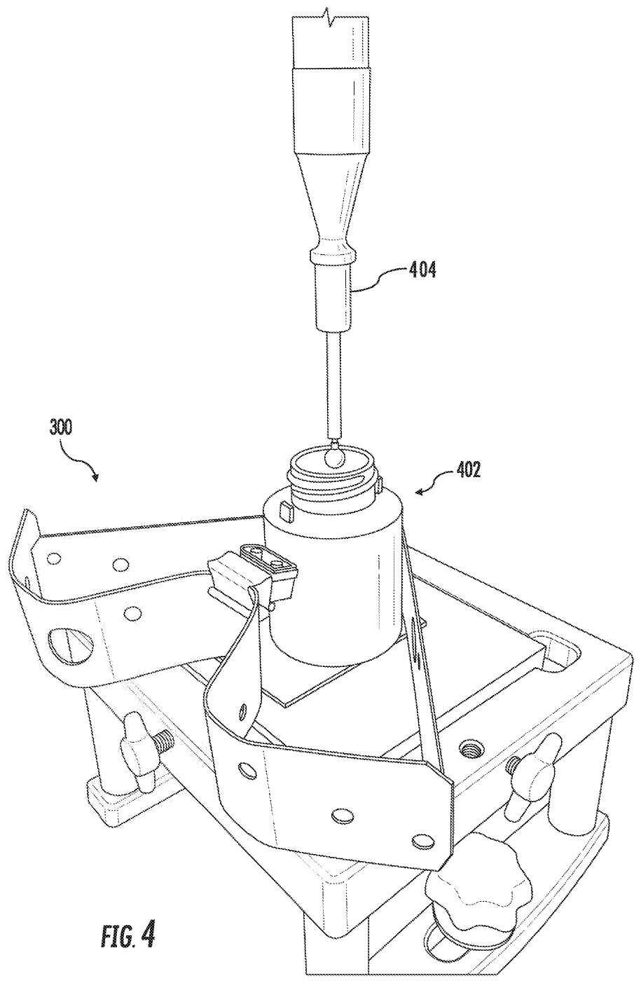

In certain embodiments, as shown in FIGS. 3-4, the mechanical test is performed on a vertically positioned article by an instrumented finger 404 having or associated with a force gauge, in which the instrumented finger 404 depresses a portion of the base of the article 402 at a defined rate. In certain embodiments, a fixture 300 having a space 302 for securely receiving the article is used to ensure uniformity of testing conditions. The force required to deform the portion of the base of the article 402 is determined, and then the instrumented finger 404 is removed from the portion of the base of the article at a defined rate and the force associated with removal of the finger 404 is also determined. For example, the instrumented finger may be a sensitive moving head associated with a force gauge. The force to deform slightly may be recorded continuously along with monitoring the force when removing the finger at the defined rate. It has been found that this measurement is able to quickly identify process changes, loading level of inorganic materials, which influence mechanical properties, and low molecular weight polymeric additives to base resin.

In certain embodiments, a method further includes forming the plastic article. For example, forming the plastic article may include compression blow forming, injection blow molding, or extrusion blow molding. In some embodiments, as shown in FIG. 2, performing the XRF and mechanical test occurs offline from forming the plastic article. In other embodiments, as shown in FIG. 1, performing the XRF and mechanical test occurs inline with forming the plastic article.

For example, in certain embodiments, the formed plastic articles are conveyed by a conveyor system. A suitable robotic mechanism (e.g., robotic arm or grabbing device) selects an article from the conveyor system according to a preset schedule and delivers each selected plastic article to the XRF and mechanical test equipment, to determine its chemical and mechanical properties and compare them to the desired specification. After completion of the XRF and mechanical test, each selected plastic article is returned to the conveyor system in a position vacated by another selected plastic article.

In certain embodiments, the XRF and the mechanical test are performed by a single apparatus. That is, both the XRF and mechanical tests may be performed on a common fixture and/or with the article remaining in a single position during performance of both analyses.

In certain embodiments, the methods also include further analytical processes, such as vision, leak detection, and wall thickness measurement testing, to supplement the information provided from the main two analytical methods.

Systems

In another aspect, as shown in FIGS. 1-2, systems 100/200 for measuring specification compliance of a plastic article 100 are provided. The systems may include any of the method steps described above and any components or features thereof, in any combination. In some embodiments, the system includes an XRF apparatus configured to identify USP elements of concern, nucleating agent level, and/or delustrant level of a plastic article, and a non-destructive mechanical test apparatus configured to depress a portion of the plastic article at a defined rate and determine a force required to deform the portion of the plastic article and the force associated with releasing the depression at a defined rate, to identify any shift in material composition or processing parameters of the article.

As discussed above, the XRF and mechanical test apparatus may be configured to provide results in less than 5 minutes. For example, the XRF apparatus may be configured to perform its analysis in less than 2 minutes and the non-destructive mechanical test apparatus may be configured to perform its analysis in less than 2 minutes.

As shown in FIGS. 1-2, the mechanical test apparatus may include an instrumented finger 104 that has or is associated with a force gauge, wherein the instrumented finger 104 is configured to depress the portion of the article at the defined rate such that the force required to deform the portion of the article is determined, and the instrumented finger 104 is configured to be removed from the portion of the article at a defined rate such that the force associated with removal of the finger is determined.

As shown in FIGS. 3-4, the mechanical test apparatus may include an instrumented finger 404 that has or is associated with a force gauge, wherein the instrumented finger 404 is configured to depress a the portion of the base of the article 402 at the defined rate. In certain embodiments, a fixture 300 having a space 302 for the article is used to ensure uniformity of testing conditions. The force required to deform the portion of the base of the article 402 is determined, and the instrumented finger 404 is configured to be removed from the portion of the base of the article at a defined rate such that the force associated with removal of the finger is determined.

In certain embodiments, the system also includes an apparatus for forming the plastic article. For example, the apparatus may be a suitable blow forming, injection blow molding, or extrusion blow molding apparatus. In some embodiments, as shown in FIG. 1, the XRF apparatus and mechanical test apparatus (collectively 100) are inline with the apparatus for forming the plastic article 102. In other embodiments, as shown in FIG. 2, the XRF apparatus and mechanical test apparatus (collectively 200) are offline from the apparatus for forming the plastic article.

In some embodiments, the XRF apparatus and mechanical test apparatus are components of a single apparatus, such that the XRF and mechanical test are performed with the plastic article positioned at one location within the apparatus.

In certain embodiments, the apparatus for forming the plastic article includes a conveyor system, and wherein the system further includes a robotic mechanism, as described above, configured to select an article from the conveyor system according to a preset schedule and deliver each selected plastic article to the XRF apparatus and mechanical test apparatus. In certain embodiments, the robotic mechanism is configured to return each article, after testing at the XRF apparatus and mechanical test apparatus, to the conveyor system in a position vacated by another selected plastic article.

In some embodiments, the system further includes one or more apparatuses for performing inclusion detection (e.g., vision and camera test), leak, and/or wall thickness measurements on the plastic article.

### EXAMPLES

Embodiments of the systems and methods disclosed herein were constructed and tested, as described below.

### Example 1: Comparison of XRF and Mechanical Testing to Typical Article Tests

Table 1 describes inline and lab tests that are typically conducted on plastic bottles and articles for determining compliance with specifications. Alongside the tests, this table lists the average time required to run the test.

TABLE 1
Typical Article Tests

| Typical Article Tests | Inline/Lab | Time Frame |
|---|---|---|
| Burst pressure | Lab | m |
| Closure torque | Lab | s |
| Coefficient of friction | Lab | m |
| Contamination | Inline | s |
| Density | Lab | m |
| Differential Scanning | Lab | m, h |
| Calometry (DSC) | | |
| Dimensions | Inline | s |
| Drop Testing | Lab | m |
| Extractables: monomers | Lab | h, d |
| and additives | | |
| Gas permeation | Lab | h |
| Impact test | Lab | m |
| Intrinsic Viscosity | Lab | h |
| IR camera for dimensions | Inline | s |
| and contamination | | |
| Leak test | Inline | s |
| Leak test | Inline | s |
| Light barrier | Lab | m |
| Moisture Analysis | Lab | m |
| Sidewall tensile properties | Lab | m, h |
| Stacking test (also | Lab | h |
| called top load) | | |
| Stress cracking | Lab | h, d |
| Thermal stability | Lab | h |
| Top load | Lab | h |
| Wall thickness | Lab | m |
| Leak test | Inline | s |

The systems and methods described herein were evaluated in comparison to the tests described in Table 1. In particular, a two-step XRF and non-destructive mechanical test process was performed on sample articles, and suitable results pertaining to chemical and structural properties of the tested articles (e.g., USP elements of concern, nucleating agent level, and/or delustrant level, the presence of inorganic and organic contaminants) were obtained within about a minute or less per step. Thus, the presently described methods and systems were found to offer a significant improvement in the time required over known test methods described in the table.

### Example 2: Detecting Changes in Nucleating Agent with Mechanical Testing of Bottle Base

Mechanical testing was performed to detect changes in the nucleating agent levels in polyethylene bottles. Nucleating agents increase crystallinity in polyethylene, which in turn increases modulus and moisture barrier properties. Therefore, a change in the nucleating agent was able to be detected by measuring the deformation of the plastic article versus force. In one instance, a known amount of force was applied and the resulting deformation was measured. In another instance, force was applied until a defined deformation was reached.

Bottles having concave bases were able to be tested in a vertical orientation, simplifying the positioning of the bottle in the system and increasing uniformity of testing conditions.

A Stable Micro Systems TA.XT plus100 Texture Analyser was used for the force measurements, commercially available from Stable Micro Systems, Godalming, United Kingdom. The TA.XT plus100 was equipped with a TA-8¼″ stainless steel sphere probe. To ensure uniformity of testing conditions, a fixture such as the one depicted in FIG. 3 was used to secure the bottle in a vertical orientation.

Bottles were prepared using commercially available resins. One resin was Marlex® 5502BN (a high density, high molecular weight polyethylene-hexene copolymer), commercially available from Chevron Phillips Chemical Company, The Woodlands, Tex., USA. Another resin was CONTINUUM™ DMDD 6620 (a bimodal high density polyethylene), commercially available from Dow Incorporated, Midland, Mich., USA. Another resin was CONTINUUM™ DMDE 6620 (a bimodal high density polyethylene), commercially available from Dow Incorporated, Midland, Mich., USA. DMDE 6620 is the same polymer as DMDD 6620, but DIVIDE 6620 includes a nucleating agent.

Some samples were prepared using a nucleating agent, such as Hyperform® HPN-20E, commercially available from Milliken Chemical Company, Spartanburg, S.C., USA. HPN-20E is supplied pre-mixed in a polyethylene carrier, referred to as a masterbatch. This masterbatch was mixed with virgin resin, such as DMDD 6620, to lower cost. For example, a mixture of 1 wt % HPN-20E masterbatch with 99 wt % DMDD 6620 may be used to form the plastic article.

The recycle-symbol on the base of the bottle was used to orient the bottle in the fixture. A 60 cc bottle having a nominal weight of 6.9 g and 3.5 wt % TiO₂ delustrant was formed on a SACMI CBF machine. This bottle was 4.27 cm in diameter and 5.97 cm tall. This bottle was secured in the fixture and the probe was pressed against the base of the bottle, as depicted in FIG. 4. The probe depressed the bottle base by 1.27 mm at a rate of 1 mm/s while the peak force required to achieve this depression distance was measured. The force continued to be measured as the probe was raised and removed from the bottle base. The results of the deformation versus force measurements are provided in Table 2.

TABLE 2
Peak Force Required to Deform Article Base by 1.27 mm

| Resin | Nucleating agent | Peak Force (g) |
|---|---|---|
| 5502BN | None | 8700 ± 50 |
| DMDD 6620 | None | 9100 ± 40 |
| DMDD 6620 | 1 wt % HPN-20E | 11800 ± 40 |
| | masterbatch | |

The force-displacement curve for compression and recovery was integrated and compared. If the ratio of the two is between 0.98 and 1, the force is considered non-destructive and linear. This computed value was used to determine the useful linear depression region for all bottles.

As shown in Table 2, the stiffness of the bottle was observed to increase when a nucleating agent is present. Therefore, the systems and methods described herein were effective to detect the presence of nucleating agent in a bottle.

### Example 3: Detecting Changes in Nucleating Agent with Mechanical Testing of Bottle Sidewall

Bottles with flat bases or double-concave bases were found to present greater difficulties when testing in a vertical orientation. Thus, the sidewall of the bottle was tested instead by positioning the bottle in a horizontal orientation. Since the sidewall thickness varies depending on the mold that is used, a greater degree of deformation was used.

A Stable Micro Systems TA.XT plus100 Texture Analyser was equipped with a TA-8¼″ stainless steel sphere probe. To ensure uniformity of testing conditions, a fixture such as the one depicted in FIG. 2 was used to secure the bottle in a horizontal orientation. A 150 cc bottle having a nominal weight of 12.6 g and 3.5 wt % TiO₂ delustrant was formed on a SACMI CBF (Compression Blow Forming) machine, commercially available from SACMI IMOLA S.C., Imola, Italy. This bottle was 5.31 cm in diameter and 9.80 cm tall. This bottle was positioned in the fixture using the recycle-symbol for orientation and the probe was pressed against the uppermost sidewall of the bottle, as shown in FIG. 2. The probe depressed the bottle by 2 mm at a rate of 1 mm/s while the force was measured. The force continued to be measured as the probe was raised and removed from the sidewall. The results of the deformation vs. force measurements are provided in Table 3.

TABLE 3
Peak Force Required to Deform Article Sidewall by 2 mm

| Resin | Peak Force (g) |
|---|---|
| 5502BN | 920 ± 20 |
| DMDD 6620 | 980 ± 20 |
| DMDE 6620 | 1050 ± 20 |

As shown in Table 3, the stiffness of the bottle was observed to increase when a nucleating agent is present (in DIVIDE 6620) versus the same polymer without a nucleating agent (DMDD 6620). Therefore, the systems and methods described herein were effective to detect the presence of nucleating agent in a bottle.

### Example 4: Detecting Changes in Nucleating Agent with XRF

A Shimadzu EDX-7000 Energy Dispersive X-ray Fluorescence Spectrometer, commercially available from Shimadzu Scientific Instruments, Kyoto, Japan, was used to perform XRF. The EDX-7000 was equipped with a filter having an effective energy of 2-5 keV and a 2 mm collimator. The EDX-7000 has the ability to measure sodium, having atomic weight 11, and uranium, having atomic weight of 92 by using a radiation source. It was determined that while the thickness of the sample is not important in most measurements, because x-rays penetrate the full sample, thin-walled samples require normalized values in order to facilitate comparison. The EDX-7000 has the capability of self-calibrating for the thickness of the sample, alleviating the variance in sidewall thickness as a result of different mold cavities. Thus, it was discovered that use of an XRF system that includes such background calibration was particularly effective at providing accurate measurements in thin-walled articles, such as bottles.

In this example, the level of Hyperform® HPN-20E present in the bottles was measured. HPN-20E is composed of zinc stearate at 34.0% and 1,2-cyclohexanedicarboxylic acid, calcium salt at 66.0%. It has been observed that the concentration of this nucleating agent in the composition affects mechanical properties by 5-10%, barrier properties by 20-50%, and significantly affects article integrity. As this nucleating agent is typically added as a masterbatch at the article manufacturing operation, control of additive is crucial to the performance of the article. XRF was found to be an effective tool for analyzing shifts in nucleating agent concentration, which can occur when equipment starts-up or raw material change may occur.

The calcium content was measured in order to calculate the total amount of HPN-20E. This test achieved excellent correlation with inductive-coupled plasma (ICP) measurements. The overall test time was 1.15 minutes, compared to 310 minutes for the typical digestion and ICP analysis process used currently. Measurement reproducibility was within 5%. A statistical algorithm such as a cumulative sum (CUSUM) allows for detecting a shift in nucleation level.

### Example 5: Detecting TiO₂ Load Level with XRF

The typical method for detecting TiO₂ load is “ashing.” Ashing involves heating a small sample of plastic in a crucible to 600° C. to pyrolyzed carbon from polyolefin. The remaining material is weighed to determine the total amount of inorganics, which amount is often deemed as filler. This ashing process requires a ventilated lab and numerous safety precautions.

In contrast, XRF provided a quantitative measurement of the titanium in TiO₂ and in other fillers that may be present in the system. Quantitatively determining the level of the fillers is impossible in ashing. In this example, the TiO₂ level was measured to be 3.3 wt %±0.07 wt % in a high density polyethylene (HDPE) sample, demonstrating a reproducibility that is equal to or superior than the ashing method.

The detection of TiO₂ load level with XRF was combined with the detection of nucleating agents with XRF, as described in Example 4. This involved a 1.4 minute cycle test, 0.9 minutes faster than performing both tests individually, and dramatically faster than currently used methods.

### Example 6: Detecting Process Variation with Mechanical Property Monitoring

The mechanical properties of plastic articles depends not only on the chemical composition, molecular architecture, and molecular weight, but heavily depends on shear and temperature during processing. In many high-stretch bottles, it is challenging to make bottles if a process temperature has deviated by more than 20° C. However, for low-stretch pharmaceutical bottles, the bottle line can continue to run even with partial heater failure. As described above in Examples 2-5, a combination of XRF and mechanical measurement was found effective to accurately identify shifts in mechanical properties very quickly. Whereas previously, chemical testing may have taken hundreds of minutes (such as for digestion and ICP analysis), in which time hundreds or thousands of plastic articles are produced, a combined XRF and mechanical method can identify these faults within moments.

In this example, 90 cc round bottles were produced via compression blow forming having cavity wall temperature thermoregulators turned off. Without these thermoregulators, the temperature of the cavity increased over time. Bottles produced from this cavity were tested at standard temperatures and elevated temperatures. As described in Examples 4 and 5, the Shimadzu EDX-7000 was used to show no change in elemental concentration of nucleating agent and delustrant. Mechanical testing of the sidewall as described in Example 3 showed a peak force increase from 1050 g to 1080 g. Thus, without stopping production from the machine, the mechanical test was able to identify a shift in the process. This method can limit waste by quickly identifying faults, thus maintaining a high quality plastic article.

### Example 7: Rapid, Non-Destructive Test

Both the mechanical testing in Examples 2 and 3, and the XRF testing of Examples 4 and 5 may be performed inline by removing the plastic article, testing it, and replacing the plastic article. Due to the necessary time to test, current testing can only occur once or twice per shift, or during start-up and/or shut-down. This can lead to the production of off-grade bottles. By combining automation via robotics and the tests disclosed herein in a semi-continuous process, the level of testing can be increased a hundredfold, subsequently leading to increased confidence in the produced bottles. Our tests demonstrated that one in every 200 bottles can be tested, up from one in every 80,000 bottles using current methods.

### Example 8: Detecting Compounded Trace API in Polymer Pellets

Previous methods for compounding trace API involved extraction of API from the polymer followed by gas chromatography (GC) or ICP spectroscopy. Both of these methods require several hours of sample preparation, which involves digestion or extended extraction.

In contrast, XRF measurement as described herein was found effective at detecting non-carbon elements in API when added to organic polymers. When preparing compounds of triclosan (C₁₂H₇Cl₃O₂) at 1000 ppm and 1800 ppm in polyethylene through compounding, a 1-3 day turnaround on analysis creates the potential for waste and the inability to actively control dosing. By using XRF, triclosan can be measured to within 3-5% of validated GC results.

When measuring triclosan via XRF, no sample preparation was needed. Instead, pellets of compounded triclosan in polyethylene were measured directly. Pellets were loaded in a cylindrical cup with a base composed of thin film. XRF as described in Example 4 was then performed. Within 45-200 seconds (depending on concentration and helium/vacuum purge cycle), the triclosan level was determined to within 3-5% reproducibility. The same pellets used in XRF can be further verified via GC because the XRF test is non-destructive.

### Example 9: Detecting Compounded Trace API in Molded Plastic Articles

As described above, traditional GC and ICP test methods are destructive. Instead, plastic articles were analyzed using XRF as described here. A robot was used to precisely position the article in the Shimadzu EDX-7000 and triclosan was measured in atmospheric conditions. After analysis, the article was replaced in the production line. Zero waste was created in the analysis and measurement of the article.

In a plastic article production facility, produced articles must be periodically tested to ensure quality. Because these articles may be produced very quickly, numerous articles are produced in the time it takes to test a sample article. If testing takes hours or days to complete, and the test demonstrates a flaw in the production line, every article produced after the tested sample article must be discarded. By using the systems and methods described herein, plastic articles can be tested in minutes, and the sample article can be reintroduced into the production because the testing is non-destructive. As a result, the amount of waste produced by a plastic article production facility is dramatically reduced.

Furthermore, because current testing takes hours or days and a failed test results in a large loss, manufacturers tend to produce thicker plastic articles. These thicker articles are less likely to fail, but require more material and have a higher weight. By using the systems and methods described herein, manufacturers can produce thinner articles and test them at a dramatically higher frequency, reducing the weight of produced articles and reducing the consumption of raw materials.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method for measuring specification compliance of a plastic article, comprising:
performing x-ray fluorescence (XRF) on the plastic article to identify U.S. Pharmacopeial Convention (USP) elements of concern, nucleating agent level, and/or delustrant level; and
performing a non-destructive mechanical test on the plastic article, the mechanical test comprising depressing a portion of the plastic article at a defined rate and determining a force required to deform the portion of the plastic article and the force associated with releasing the depression at a defined rate, to identify any shift in material composition or processing parameters of the plastic article,
wherein the mechanical test is performed by an instrumented finger comprising or associated with a force gauge, wherein the instrumented finger depresses the portion of the plastic article at the defined rate and the force required to deform the portion of the plastic article is determined.

2. The method of claim 1, wherein the method is completed in less than 5 minutes.

3. The method of claim 1, wherein the USP elements of concern comprise one or more of arsenic, cadmium, lead, and mercury.

4. The method of claim 1, wherein the XRF is performed in less than 2 minutes.

5. The method of claim 1, wherein the non-destructive mechanical test is performed in less than 2 minutes.

6. The method of claim 1, wherein the mechanical test is configured to determine load levels of inorganic materials, crystallinity and/or differences in flow characteristic of polymer comprising the plastic article.

7. The method of claim 1, further comprising forming the plastic article.

8. The method of claim 7, wherein forming the plastic article comprises compression blow forming, injection blow molding, or extrusion blow molding.

9. The method of claim 7, wherein performing the XRF and mechanical test occurs offline from forming the plastic article.

10. The method of claim 7, wherein performing the XRF and mechanical test occurs inline with forming the plastic article.

11. The method of claim 10, wherein the formed plastic articles are conveyed by a conveyor system, and wherein a robotic mechanism selects a plastic article from the conveyor system according to a preset schedule and delivers each selected plastic article to the XRF and mechanical test.

12. The method of claim 11, wherein, after completion of the XRF and mechanical test, each selected plastic article is returned to the conveyor system in a position vacated by another selected plastic article.

13. The method of claim 11, wherein the XRF and the mechanical test are performed by a single apparatus.

14. The method of claim 1, further comprising performing vision, leak, and/or wall thickness measurements on the plastic article.

15. A system for measuring specification compliance of a plastic article, comprising:
an x-ray fluorescence (XRF) apparatus configured to identify U.S. Pharmacopeial Convention (USP) elements of concern, nucleating agent level, and/or delustrant level of the plastic article; and
a non-destructive mechanical test apparatus configured to depress a portion of the plastic article at a defined rate and determine a force required to deform the portion of the plastic article and the force associated with releasing the depression at a defined rate, to identify any shift in material composition or processing parameters of the plastic article,
wherein the mechanical test apparatus comprises an instrumented finger comprising or associated with a force gauge, wherein the instrumented finger is configured to depress the portion of the plastic article at the defined rate such that the force required to deform the portion of the plastic article is determined, and wherein the instrumented finger is configured to be removed from the portion of the plastic article at a defined rate such that the force associated with removal of the finger is determined.

16. The system of claim 15, wherein the XRF and mechanical test apparatus are configured to provide results in less than 5 minutes.

17. The system of claim 15, wherein the USP elements of concern comprise one or more of arsenic, cadmium, lead, and mercury.

18. The system of claim 15, wherein the XRF apparatus is configured to perform its analysis in less than 2 minutes.

19. The system of claim 15, wherein the non-destructive mechanical test apparatus is configured to perform its analysis in less than 2 minutes.

20. The system of claim 15, wherein the mechanical test apparatus is configured to determine load levels of inorganic materials and/or low molecular weight polymeric additives in the plastic article.

21. The system of claim 15, further comprising an apparatus for forming the plastic article.

22. The system of claim 21, wherein the apparatus for forming the plastic article comprises a blow forming, injection blow molding, or extrusion blow molding apparatus.

23. The system of claim 15, wherein the XRF apparatus and mechanical test apparatus are components of a single apparatus, such that the XRF and mechanical test are performed with the plastic article positioned at one location within the apparatus.

24. The system of claim 21, wherein the XRF apparatus and mechanical test apparatus are offline from the apparatus for forming the plastic article.

25. The system of claim 21, wherein the XRF apparatus and mechanical test apparatus are inline with the apparatus for forming the plastic article.

26. The system of claim 21, wherein the apparatus for forming the plastic article comprises a conveyor system, and wherein the system further comprises a robotic mechanism configured to select a article from the conveyor system according to a preset schedule and deliver each selected plastic article to the XRF apparatus and mechanical test apparatus.

27. The system of claim 26, wherein the robotic mechanism is configured to return each plastic article, after testing at the XRF apparatus and mechanical test apparatus, to the conveyor system in a position vacated by another selected plastic article.

28. The system of claim 15, further comprising performing one or more apparatuses for performing vision, leak, and/or wall thickness measurements on the plastic article.
